(19) United States
(12) Patent Application Publication
(10) Pub. No.: US 2013/0056537 A1
(43) Pub. Date: Mar. 7, 2013

(54) BARRIER LAYER DIELECTRIC FOR RFID CIRCUITS

(71) Applicants: Vince Arancio, Bristol (GB); Jay Robert Dorfman, Durham, NC (US)

(72) Inventors: Vince Arancio, Bristol (GB); Jay Robert Dorfman, Durham, NC (US)

(73) Assignee: E. I. DU PONT DE NEMOURS AND COMPANY, Wilmington, DE (US)

(21) Appl. No.: 13/225,873

(22) Filed: Sep. 6, 2011

(51) Int. Cl. C08L 75/04; C08K 5/07; C08K 3/36; G06K 19/02

(52) U.S. Cl. 235/488; 524/357

(57) ABSTRACT

This invention is directed to a polymer thick film barrier layer dielectric composition. Dielectrics made from the composition can be used in various electronic applications to protect electrical elements and particularly to insulate and protect both the conductive silver antenna above it and the polycarbonate substrate below it in RFID applications.

### FIELD OF THE INVENTION

This invention is directed to a polymer thick film barrier layer dielectric composition. Dielectrics made from the composition can be used in various electronic applications to protect electrical elements and particularly to insulate and protect both the conductive antenna silver above it and the polycarbonate substrate below it in radio frequency identification (RFID) applications.

### BACKGROUND OF THE INVENTION

Dielectrics have long been used to protect electrical elements. They have also been used as isolating layers. Although they have been used for years in these types of applications, the use of dielectrics as barrier layers during thermoforming procedures is not common. This is particularly important in RFID circuits where a highly conductive silver antenna is used and the silver is not compatible with the underlying substrate. One of the purposes of this invention to alleviate these issues and produce a RFID antenna construction in which the printed silver antenna can be used on a substrate of choice such as a polycarbonate.

### SUMMARY OF THE INVENTION

This invention relates to a polymer thick film barrier layer dielectric composition comprising:
(a) 80-98 wt % of an organic medium comprising 10-50 wt % thermoplastic urethane resin dissolved in a first organic solvent, wherein the weight percent of the organic medium is based on the total weight of the polymer thick film barrier layer dielectric composition and wherein the weight percent of the thermoplastic urethane resin is based on the total weight of the organic medium; and
(b) 2-20 wt % of a second organic solvent, wherein the second organic solvent is diacetone alcohol and wherein the weight percent of the second organic solvent is based on the total weight of the polymer thick film barrier layer dielectric composition.

The invention is further directed to using the polymer thick film barrier layer dielectric to form a protective and/or insulating layer in RFID electrical circuits and, in particular, in the thermoforming of the total construction.

### DETAILED DESCRIPTION OF INVENTION

The invention relates to a polymer thick film barrier layer dielectric composition for use in thermoforming electrical circuits and, in particular, RFID circuits. A layer of barrier layer dielectric is printed and dried on a substrate so as to protect that substrate from other layers that are subsequently deposited on the barrier layer dielectric.

The substrate commonly used in polymer thick film RFID circuit is a polycarbonate (PC), a polyester (PET), e.g., polyethylene naphthalate (PEN), a polyimide (PI) and others. PC is generally preferred since it can be thermoformed. However, PC is very sensitive to the solvents used in the layers deposited on it.

The polymer thick film (PTF) barrier layer dielectric composition is comprised of (i) an organic medium comprising a polymer resin dissolved in a first organic solvent and (ii) a second organic solvent. Additionally, powders and printing aids may be added to improve the composition.

### Organic Medium

The organic medium is comprised of a thermoplastic urethane resin dissolved in a first organic solvent. In one embodiment the organic medium is 80-98 wt % of the total weight of the polymer thick film barrier layer dielectric composition. The urethane resin must achieve good adhesion to both the electrical element, e.g., the RFID silver layer that is deposited on it and the underlying substrate. It must be compatible with and not adversely affect the performance of the electrical element.

In one embodiment the thermoplastic urethane resin is 10-50 wt % of the total weight of the organic medium. In another embodiment the thermoplastic urethane resin is 25-45 wt % of the total weight of the organic medium and in still another embodiment the thermoplastic urethane resin is 15-25 wt % of the total weight of the organic medium. In one embodiment the thermoplastic urethane resin is a urethane homopolymer. In another embodiment the thermoplastic urethane resin is a polyester-based copolymer.

The polymer resin is typically added to the organic solvent by mechanical mixing to form the medium. Solvents suitable for use in the polymer thick film composition are recognized by one of skill in the art and include acetates and terpenes such as carbitol acetate and alpha- or beta-terpineol or mixtures thereof with other solvents such as kerosene, dibutylphthalate, butyl carbitol, butyl carbitol acetate, hexylene glycol and high boiling alcohols and alcohol esters. In addition, volatile liquids for promoting rapid hardening after application on the substrate may be included. In many embodiments of the present invention, solvents such as glycol ethers, ketones, esters and other solvents of like boiling points (in the range of 180° C. to 250° C.), and mixtures thereof may be used. Various combinations of these and other solvents are formulated to obtain the viscosity and volatility requirements desired. The solvents used must solubilize the resin.

### Second Organic Solvent

The second organic solvent is diacetone alcohol. In one embodiment the diacetone alcohol is 2-20 wt % of the total weight of the polymer thick film barrier layer dielectric composition. In another embodiment the diacetone alcohol is 4-18 wt % of the total weight of the polymer thick film barrier layer dielectric composition and in still another embodiment the diacetone alcohol is 8-12 wt % of the total weight of the polymer thick film barrier layer dielectric composition

### Additional Powders

Various powders may be added to the PTF barrier layer dielectric composition to improve adhesion, modify the rheology and increase the low shear viscosity thereby improving the printability. One such powder is fumed silica.

### Application of the PTF Barrier Layer Dielectric Composition

The PTF barrier layer dielectric composition, also referred to as a “paste”, is typically deposited on a substrate, such as polycarbonate, that is impermeable to gases and moisture. The substrate can also be a sheet of a composite material made up of a combination of plastic sheet with optional metallic or dielectric layers deposited thereupon.

The deposition of the PTF barrier layer dielectric composition is performed typically by screen printing, but other deposition techniques such as stencil printing, syringe dispensing or coating techniques can be utilized. In the case of screen-printing, the screen mesh size controls the thickness of the deposited thick film.

Generally, a thick film composition comprises a functional phase that imparts appropriate electrically functional properties to the composition. The functional phase comprises electrically functional powders dispersed in an organic medium that acts as a carrier for the functional phase. Generally, the composition is fired to burn out both the polymer and the solvent of the organic medium and to impart the electrically functional properties. However, in the case of a polymer thick film, the polymer portion of the organic medium remains as an integral part of the composition after drying.

The PTF barrier layer dielectric composition is processed for a time and at a temperature necessary to remove all solvent. For example, the deposited thick film is dried by exposure to heat at 140° C. for typically 10-15 min.

### RFID Circuit Construction

The base substrate used is typically 10 mil thick polycarbonate. The barrier layer dielectric is printed and dried as per the conditions described above. Several layers can be printed and dried. A highly conductive RFID silver antenna composition such as DuPont 5064 is then printed and dried under the same conditions used for the barrier layer. Subsequent steps which may include thermoforming of the entire unit is typical in the production of 3D antenna circuits. If the barrier layer dielectric is not used, the silver antenna composition will craze or deform the polycarbonate substrate and a functional circuit cannot be built.

### EXAMPLE 1

The PTF barrier layer dielectric composition was prepared in the following manner. The organic medium was prepared by mixing 20.0 wt % Desmocoll 540 polyurethane (Bayer MaterialScience LLC, Pittsburgh, Pa.) with 80.0 wt % dibasic esters (obtained from DuPont Co., Wilmington, Del.) organic solvent. The molecular weight of the resin was approximately 20,000. This mixture was heated at 90° C. for 1-2 hours to dissolve all the resin. 10 wt % diacetone alcohol (obtained from Eastman Chemical, Kingsport, Tenn.) was added to 90 wt % organic medium and mixed.

The PTF barrier layer dielectric composition, based on the total weight of the composition, was:

| | |
|---|---|
| 90.00 wt % | Organic Medium |
| 10.00 wt % | Diacetone Alcohol Solvent |

This composition was mixed for 30 minutes on a planetary mixer.

A RFID circuit was then fabricated as follows. On a 10 mil thick polycarbonate substrate, a blanket print of the above PTF barrier layer dielectric composition was printed with a 280 stainless steel screen and dried at 120° C. for 10 min. A pattern of a series of interdigitated silver lines were printed with DuPont silver paste 5064 (DuPont Co., Wilmington, Del.) using a 280 mesh stainless steel screen. The patterned lines were dried at 120° C. for 15 min. in a forced air box oven. The part was inspected and no evidence of crazing or deformation of the underlying substrate was found.

### COMPARATIVE EXPERIMENT 1

A RFID circuit was produced exactly as described in Example 1. The only difference was that the PTF barrier layer dielectric composition was not used. Inspection of the substrate showed that the silver composition crazed and severely deformed the underlying polycarbonate substrate.

### COMPARATIVE EXPERIMENT 2

A RFID circuit was produced exactly as described in Example 1. The only difference was that the PTF barrier layer dielectric composition used did not contain any diacetone alcohol solvent. Inspection of the substrate showed that both the PTF barrier layer dielectric and the silver composition crazed and severely deformed the underlying polycarbonate substrate.

The improvement in performance as a result of the barrier layer dielectric is apparent from the results shown above. Additionally, the protective effect of using the diacetone alcohol solvent is quite apparent.

What is claimed is:

1. A polymer thick film barrier layer dielectric composition comprising:
(a) 80-98 wt % of an organic medium comprising 10-50 wt % thermoplastic urethane resin dissolved in a first organic solvent, wherein the weight percent of said organic medium is based on the total weight of said polymer thick film barrier layer dielectric composition and wherein the weight percent of said thermoplastic urethane resin is based on the total weight of said organic medium; and
(b) 2-20 wt % of a second organic solvent, wherein said second organic solvent is diacetone alcohol and wherein the weight percent of said second organic solvent is based on the total weight of said polymer thick film barrier layer dielectric composition.

2. The polymer thick film barrier layer dielectric composition of claim 1, wherein said thermoplastic urethane resin is a urethane homopolymer or a polyester-based copolymer

3. The polymer thick film barrier layer dielectric composition of claim 2, wherein said thermoplastic urethane resin is a polyester-based copolymer.

4. The polymer thick film barrier layer dielectric composition of claim 1 further comprising fumed silica.

5. A RFID circuit comprising a barrier layer dielectric formed from the polymer thick film barrier layer dielectric composition of any of claims 1-4.

6. The RFID circuit comprising a barrier layer dielectric formed from the polymer thick film barrier layer dielectric composition of any of claims 1-4, where said RFID circuit is thermoformed.
